(19) United States
(12) Patent Application Publication
(10) Pub. No.: US 2017/0204695 A1
(43) Pub. Date: Jul. 20, 2017

(54) SELF HEALING BLOWOUT PREVENTER SEALS AND PACKERS

(71) Applicant: General Electric Company, Schenectady, NY (US)

(72) Inventors: Dev Bodhayan, Niskayuna, NY (US); Deepak Trivedi, Niskayuna, NY (US); Jifeng Wang, Niskayuna, NY (US); Joseph Incavo, Houston, TX (US)

(21) Appl. No.: 15/001,268

(22) Filed: Jan. 20, 2016

(51) Int. Cl. E21B 33/06; C09K 8/44

(52) U.S. Cl. CPC E21B 33/061; E21B 33/062; C09K 8/44

(57) ABSTRACT

Provided herein are methods for increasing the life of blowout preventers comprising directing self-healing materials to regions of high stress or strain in the blowout preventers.

### BACKGROUND

The disclosure relates generally to extending the reliability of blowout preventers.

Oil and gas field operations typically involve drilling and operating wells to locate and retrieve hydrocarbons. Rigs are positioned at well sites in relatively deep water. Tools, such as drilling tools, tubing and pipes are deployed at these wells to explore submerged reservoirs. It is important to prevent spillage and leakage of fluids from the well into the environment. A significantly large pressure kick can result in a “blowout” of drill pipe, casing, drilling mud, and hydrocarbons from the wellbore, which can result in failure of the well.

Blowout preventers (“BOPs”) are commonly used in the drilling and completion of oil and gas wells to protect drilling and operational personnel, as well as the well site and its equipment, from the effects of a blowout. In a general sense, a blowout preventer is a remotely controlled valve or set of valves that can close off the wellbore in the event of an unanticipated increase in well pressure. Modern blowout preventers typically include several valves arranged in a “stack” surrounding the drill string. The valves within a given stack typically differ from one another in their manner of operation, and in their pressure rating, thus providing varying degrees of well control. Longevity and reliability of BOPs is critical for safe functioning of oil wells.

A typical BOP stack is made up of several ram preventers, topped off with an annular preventer. If a kick is detected, the annular BOP is usually closed first and then the ram is used as a backup if the annular BOP should fail. Multiple blowout preventers of the same type are frequently provided for redundancy, to ensure effectiveness of fail-safe devices.

Typically BOP packers comprise elastomeric polymers which are subject to high pressures and high temperatures in the field. Exposure of elastomeric seals to extreme high temperatures can cause physical and/or chemical deterioration where the seal will initially soften and then swell causing increased friction in dynamic applications. High pressure applications are also prone to failure because room temperature tests may provide inaccurate results. Over time, irreversible chemical changes occur under high pressure/high temperature that increase seal hardness as well as induce compression set and volumetric changes.

Certain industrial activities, such as oil and gas extraction, have increasingly expanded to subsea locations, as the number of available land-based sites has declined. Subsea wells require BOPs to remain submerged for as long as a year in extreme conditions. As a result, BOP assemblies for subsea wells have grown larger and heavier while the space allotted for BOP stacks on existing offshore rigs has not grown commensurately. Accordingly, there is a need in the field for increasing safe operating capacity and extending the life of the BOPs during oil and gas extraction.

### BRIEF DESCRIPTION

One critical failure mode of conventional BOP packers/seals is cracking under load of high pressure or high temperature (HP/HT) and repeated cycling. In order to improve the longevity and operating range of the existing packers, provided herein are BOP sealers/packer wherein the elastomer matrix in the packers is modified with self-healing characteristics in regions which are susceptible to cracking under load, thereby allowing for in situ healing of the cracks and prevention of degradation of the matrix to the point of failure. Further, the directed sealers/packers described herein are designed in such a way that a self-healing process is triggered only when a crack is propagated, and not during the molding and/or normal operation of the packer.

In one aspect, provided herein are blowout preventers (BOP) comprising
at least one elastomeric packer; and
at least one self-healing material, directed to regions of high stress or high strain in said packer, dispersed therein.

In a further aspect, provided herein are computer-implemented methods for identifying optimized microcapsule diameters, for placement of microcapsules in regions of high stress or high strain in a BOP packer. In yet another aspect, provided herein are computer-implemented methods for identifying regions of high stress or high strain in a BOP packer, and directing placement of at least one self-healing material comprising a polar liquid additive or a microcapsule comprising a self-healing agent thereto.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a cross-sectional view of a blowout preventer stack 10. The stack comprises a first blowout preventer 14 which is comprised of a pair of variable rams 16, a second blowout preventer 18 including a pair of blind shear rams (detail not shown in FIG. 1), and one or more annular blowout preventers 23. The blowout preventer stack is mounted on a wellhead casing 12. The wellhead casing 12 is disposed around a wellbore 22 formed through a surface 24 by a tubular member, such as, a drill pipe 26. In one example, a drill bit (not shown in FIG. 1) is coupled to a lower end of the drill pipe 26 which extends through the wellhead casing 12 and the wellbore 22 for extracting hydrocarbons from a reservoir.

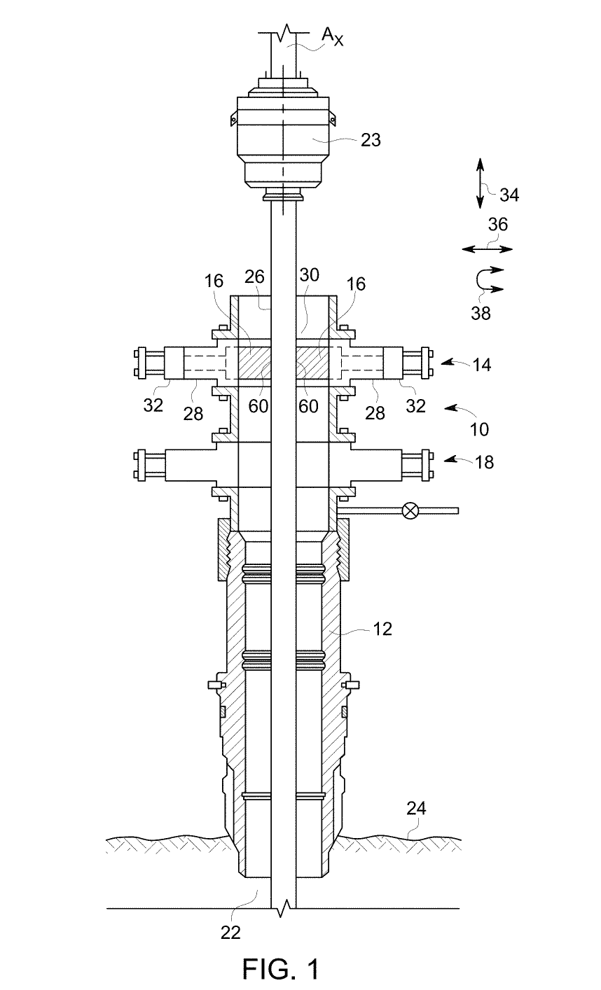

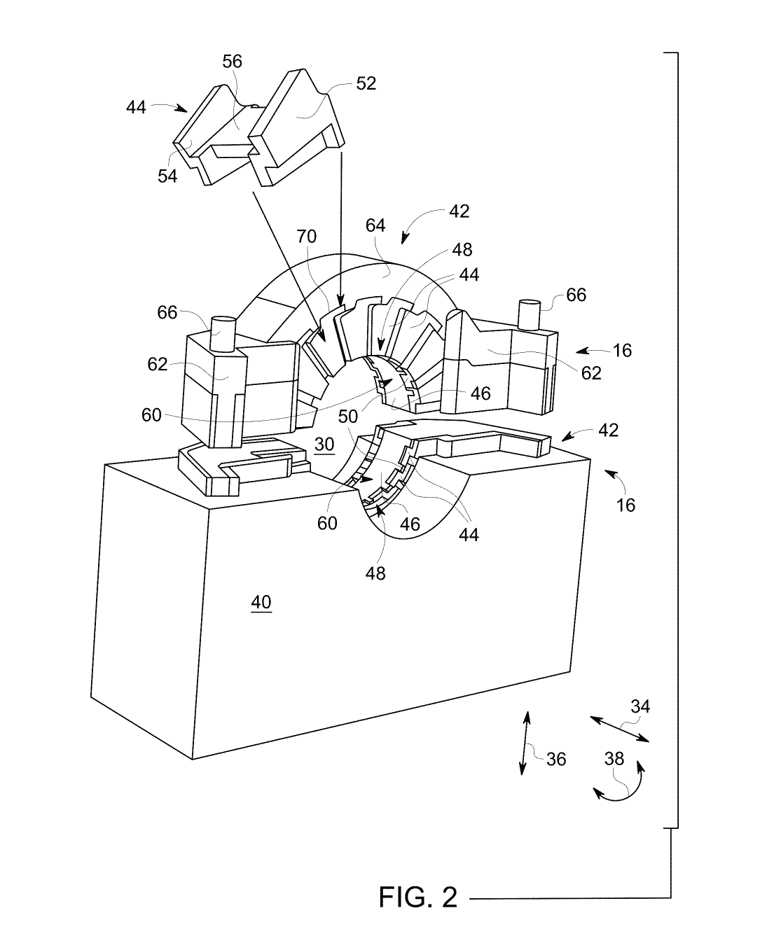

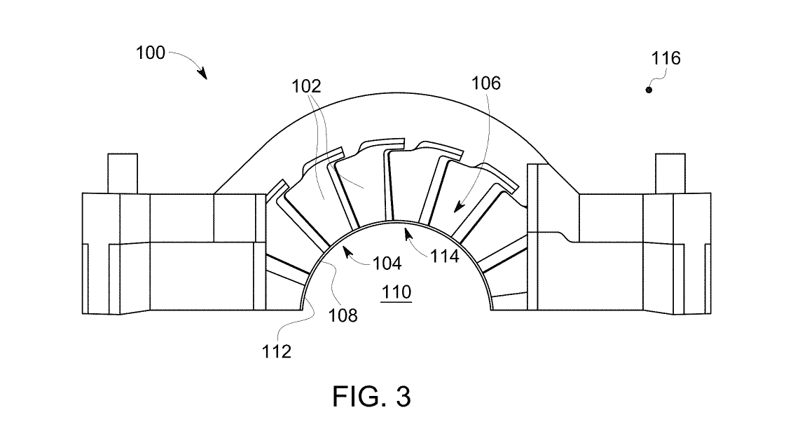

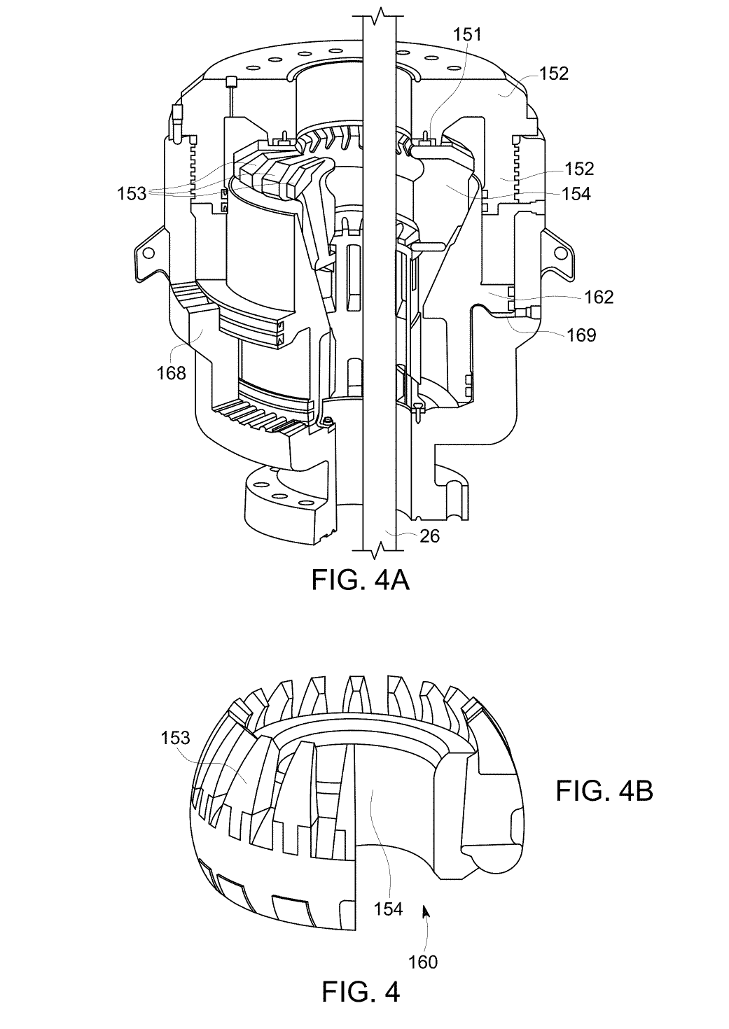

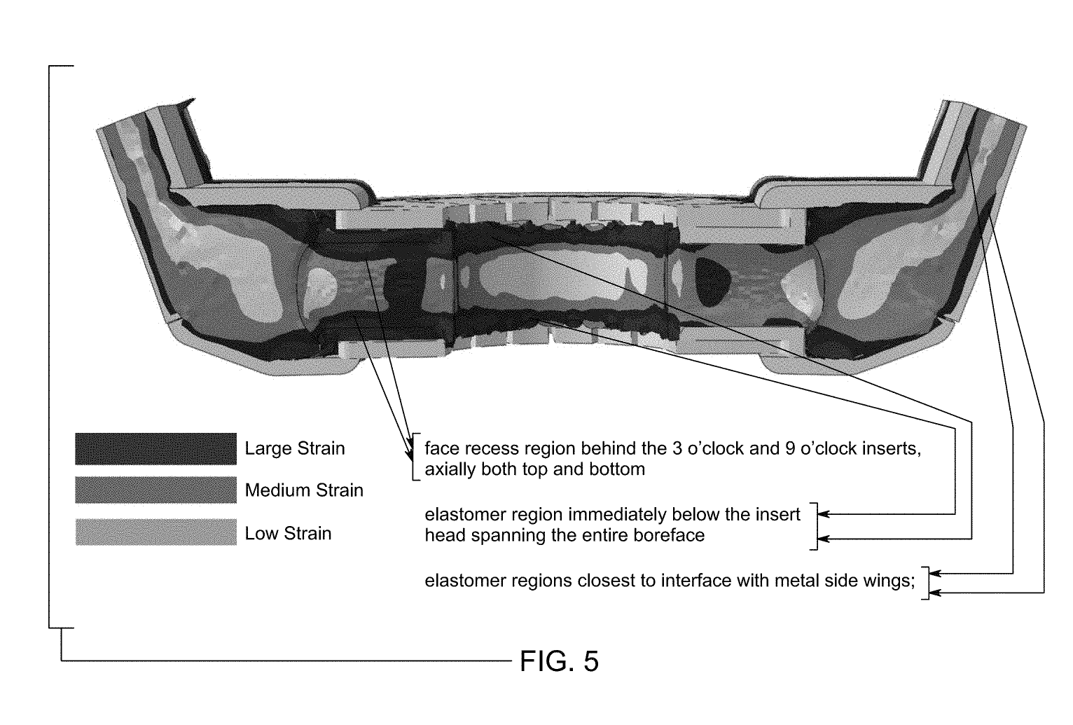

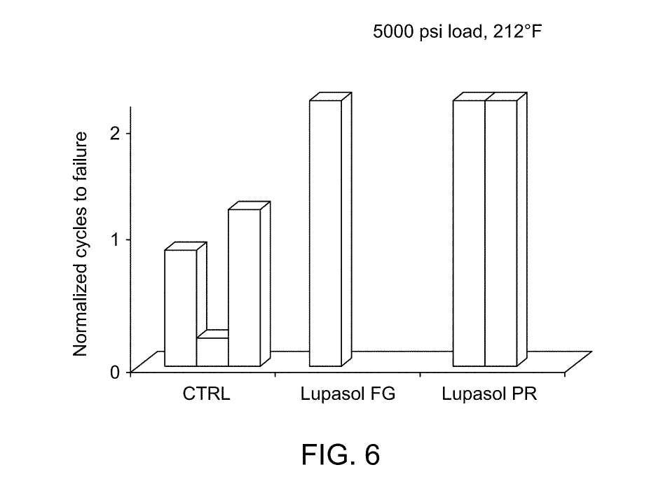

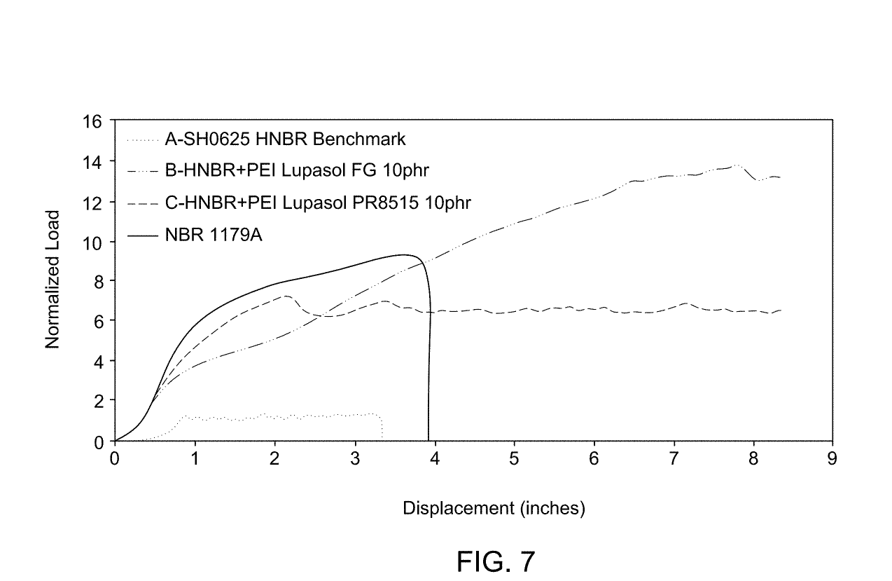

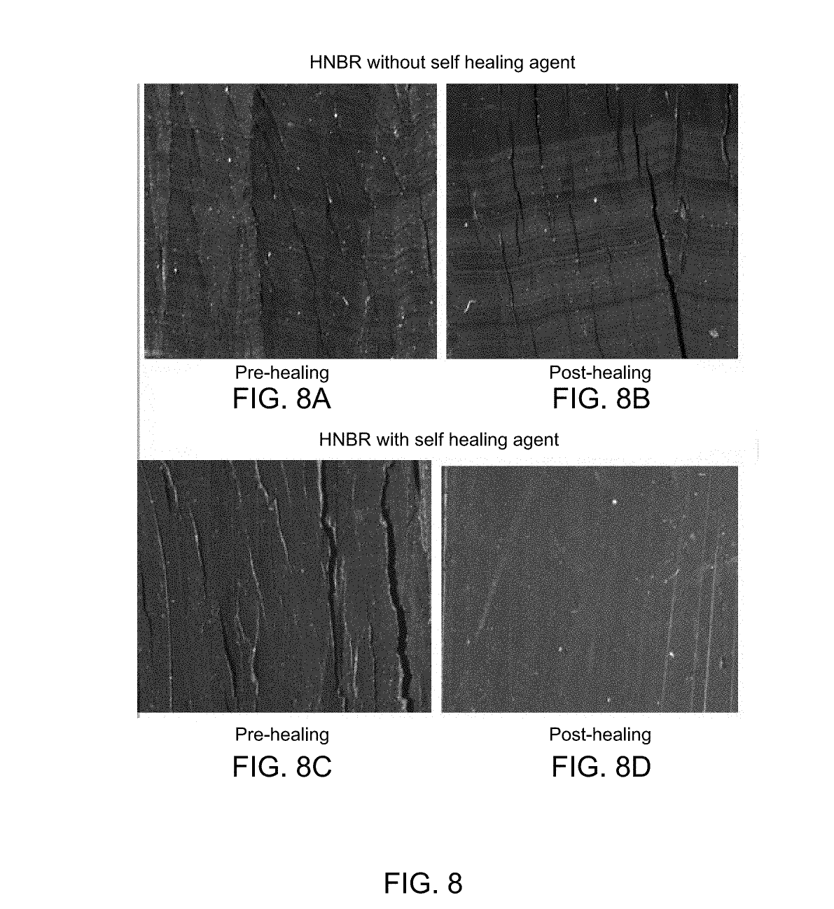

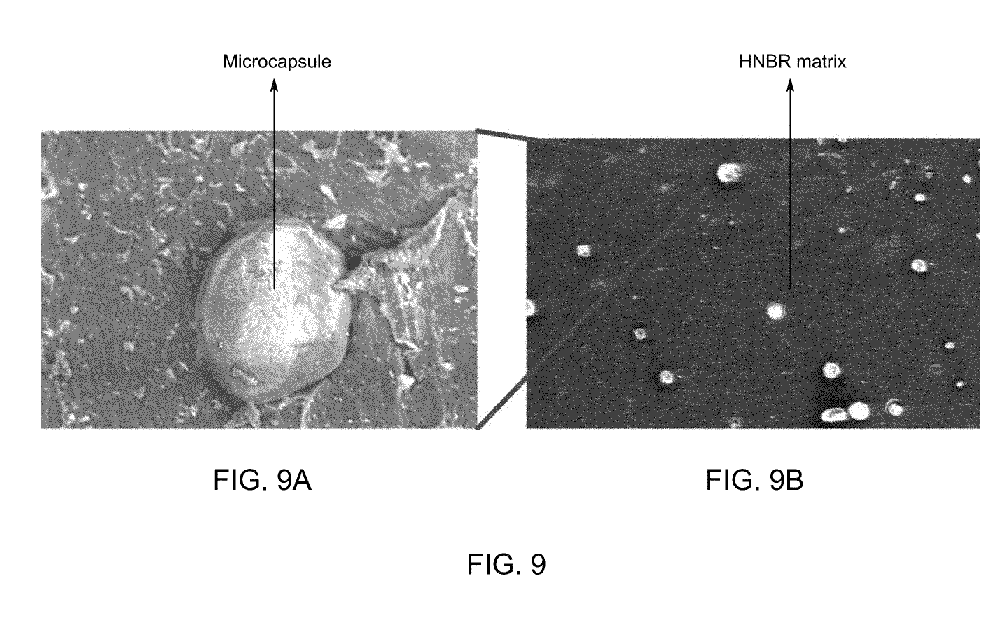

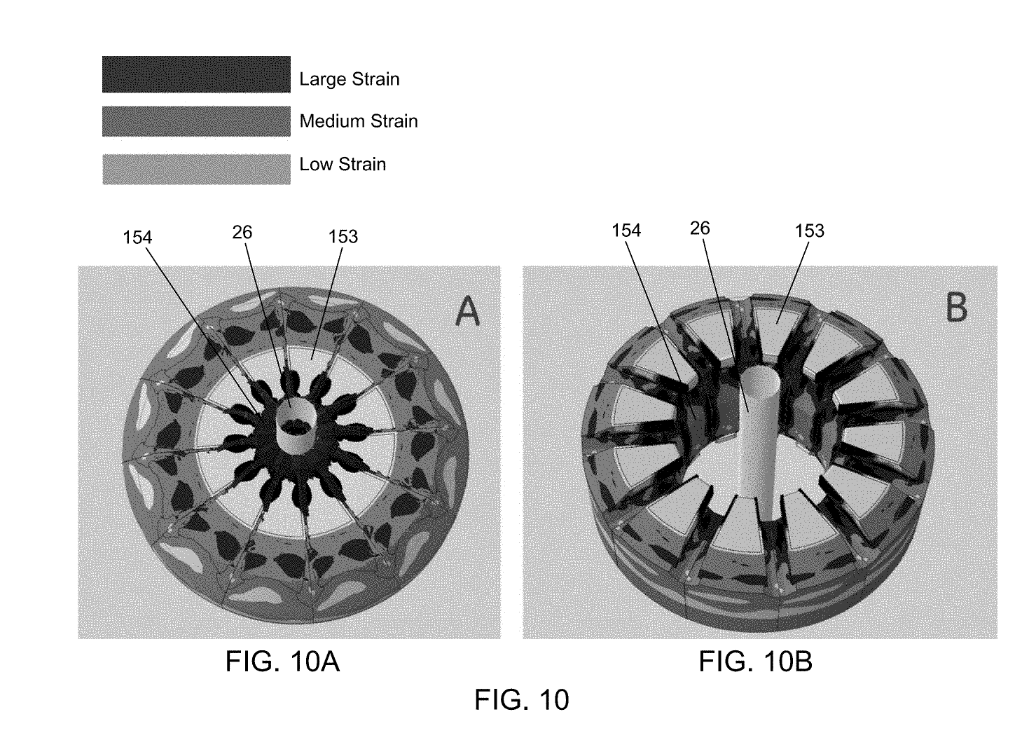

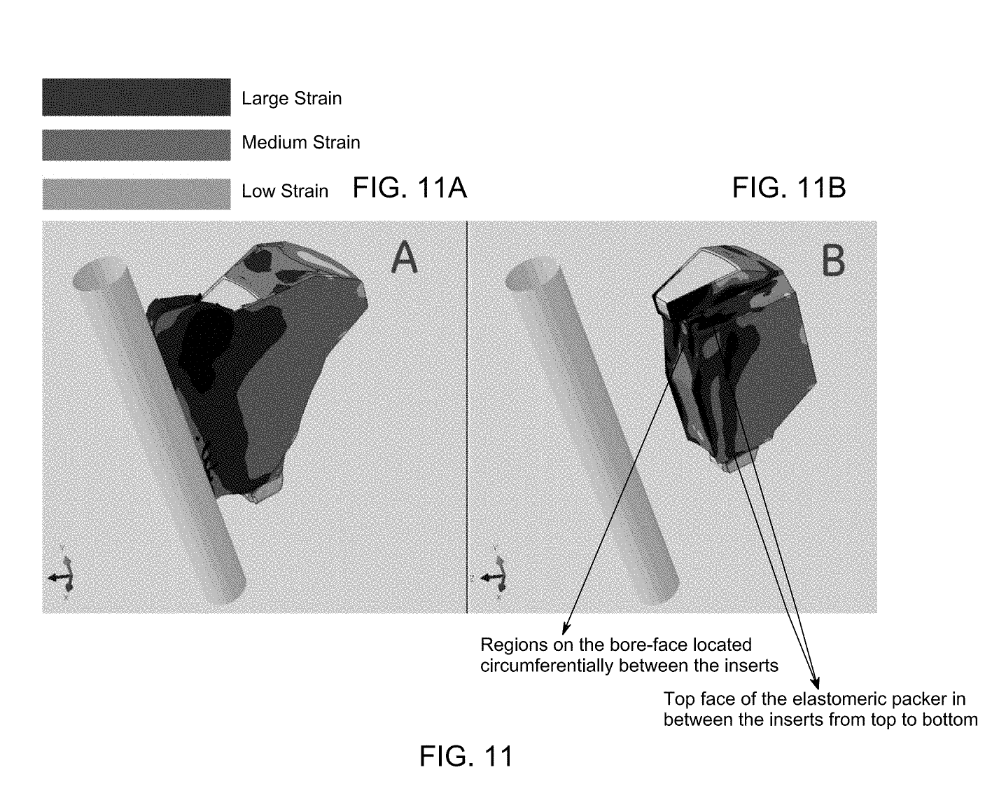

The BOP 14 is mounted below the one or more annular blowout preventers on an upper end (not labeled in FIG. 1) of the wellhead casing 12. The BOP 14 includes a housing 28, the pair of variable rams 16, and a pair of biasing devices 32. The housing 28 has an opening 30 which is configured to receive the drill pipe 26. The pair of variable rams 16 is disposed facing each other within the housing 28. Each of the biasing devices 32 is coupled to a corresponding variable ram of the pair of variable rams 16. In certain embodiments, each of the biasing devices 32 may include a piston configured to reciprocate within a cylinder and a connecting rod coupled to such piston. Each biasing device 32 is configured to selectively move the pair of variable rams 16 laterally in and out of the housing 28 relative to the opening 30. Various other types of biasing device 32 are envisioned without limiting the scope of the present technique.

In certain embodiments, each variable ram 16 may include a ram block and a ram packer assembly disposed at least in part within the ram block. In such embodiments, the ram packer assembly may include a plurality of inserts (not shown in FIG. 1) and a packer member (not shown in FIG. 1). The variable ram 16 is discussed in greater detail below. In some embodiments, the second blowout preventer 18 is disposed below the BOP 14 and is mounted on the wellhead casing 12.

It should be noted that in a cylindrical coordinate system, reference numeral 34 represents an axial direction of the variable ram 16, reference numeral 36 represents a radial direction of the variable ram 16, and reference numeral 38 represents a circumferential direction of the variable ram 16.

During operation, the drill pipe 26 is configured to rotate along the circumferential direction 38 so as to excavate the wellbore 22 and extract hydrocarbons (fluid) from the reservoirs along the wellhead casing 12. In such embodiments, the extracted fluid from the reservoirs may be transported to a distant fluid storage facility through pipelines coupled to the wellhead casing 12. In some embodiments, during certain transient operating conditions, each of the biasing devices 32 is configured to move a corresponding variable ram 16 out of the housing 28 towards the opening 30. In such embodiments, a bore face 60 (FIG. 2) of each variable ram 16 seals the drill pipe 26 so as to restrain a flow of the fluid along the wellhead casing 12. In other words, the pair of variable rams 16 closes the bore faces 60 against the drill pipe 26 to restrain the flow of the fluid along the wellhead casing 12. In some other embodiments, during certain transient operating conditions, the second blowout preventer 18 may be configured to cut through the drill pipe 26 as the pair of blind shear rams closes off the wellhead casing 12 to seal the wellbore 22 from an external environment. In one or more embodiments, the transient operation conditions may include extreme high pressure in the wellbore 22 and/or uncontrolled flow of the fluid along the wellhead casing 12. In one or more embodiments, the pair of variable rams 16 is configured to provide a uniform and high contact pressure between a packer member and the drill pipe 26, thereby preventing leakage of the fluid.

FIG. 2 illustrates a perspective view of a pair of variable rams 16 of FIG. 1 in accordance with one embodiment of the present technique. Each variable ram 16 includes a ram block 40 and a ram packer assembly 42. Although, in the illustrated embodiment, only one ram block 40 and a portion of one ram packer assembly 42 are shown to simplify the illustration of the pair of variable rams 16, however, the illustrated embodiment should not be construed as a limitation of the present technique. In one embodiment, each of the biasing devices 32 (as shown in FIG. 1) is coupled to a corresponding ram block 40 for selectively moving the pair of variable rams 16 in and out of the housing 28 (as shown in FIG. 1).

The ram packer assembly 42 is disposed at least in part within the ram block 40. In one embodiment, the ram packer assembly 42 includes a plurality of inserts 44 and a packer member 46. In the illustrated embodiment, each insert 44 of the plurality of inserts 44 includes a top plate 52, a bottom plate 54, and a central web 56 interconnecting the top plate 52 with the bottom plate 54. In certain embodiments, the plurality of inserts 44 is made of a metal. The plurality of inserts 44 is disposed adjacent to each other to form an insert array 48. In one embodiment, the insert array 48 includes a peripheral surface 50 which is disposed facing an opening 30 configured to receive a drill pipe 26 (as shown in FIG. 1).

In one embodiment, the packer member 46 is coupled to at least a portion of the plurality of inserts 44 for providing a unitary or integral structure to the ram packer assembly 42. In certain embodiments, the packer member 46 protrudes from the peripheral surface 50 of the insert array 48 into the opening 30 to define a bore face 60 of each variable ram 16. Specifically, the packer member 46 protrudes inwardly towards the opening 30 along a radial direction 36 of the variable ram 16. Further, the packer member 46 extends along a circumferential direction 38 of the variable ram 16.

In one embodiment, the ram packer assembly 42 further includes a pair of wing seals 62, a packer side seal 64, and a pair of pins 66. The packer side seal 64 is coupled to another peripheral surface 70 of the insert array 48, disposed opposite to the peripheral surface 50. Each wing seal of the pair of wing seals 62 is coupled to a corresponding peripheral side of the ram packer assembly 42. Each pin of the pair of pins 66 is coupled to a corresponding wing seal of the pair of wings seals 62. In such embodiments, the ram packer assembly 42 is disposed at least in part in the ram block 40 and coupled to the ram block 40 via the pair of pins 66 and a corresponding pair of slots (not shown in FIG. 2) formed in the ram block 40.

FIG. 3 illustrates a schematic diagram of a typical ram packer assembly 100. In the illustrated embodiment, the ram packer assembly 100 includes a plurality of inserts 102 and a packer member 104. The plurality of inserts 102 is configured to form an insert array 106 having a peripheral surface 108 disposed facing an opening 110. Further, a peripheral surface 112 of the packer member 104 is aligned with the peripheral surface 108 of the insert array 106 to define a bore face 114 of a variable ram. Specifically, the peripheral surface 112 of the packer member 104 is aligned with the peripheral surface 108 of the insert array 106 along an axial direction 116 of the variable ram. In such embodiments, during operation of the variable ram, the packer member 104 at the bore face 114 is exposed to high pressure and high temperature conditions. Under high pressure (HP) and/or high temperature (HT) conditions, the packer member 104 (see FIG. 3) at the bore face 114, (see FIG. 3) may deform and wear, thereby resulting in failure of the packer member 104. The directed self-healing packers described herein advantageously reduce the wear/depletion of the packer member 104.

FIG. 4 illustrates a schematic view of a typical annular packer assembly 150 which is located circumferentially around a drill pipe 26. In the illustrated embodiment, the annular packer assembly 150 includes a wear plate 151 that eliminates metal to metal contact between the packing unit inserts and the BOP latched head 152. A plurality of inserts 153 and a packer member 154 are configured to form a sealing element 160 disposed around the drill pipe 26. The closing of the BOP is driven by hydraulic pressures which push a closing chamber 169 to raise the piston 162 and squeeze the packing unit 160 radially inward for sealing.

FIG. 5 shows finite element analysis (FEA) conducted on a packer with regions of high strain labeled as large strain, medium strain or small strain. A similar analysis can be conducted to identify regions of high stress in a packer.

FIG. 6 shows improved fatigue life of an elastomer HNBR in the presence of Lupasol® FG and Lupasol® PR.

FIG. 7 shows trouser tear performance comparison of elastomers HNBR and NBR in the presence of Lupasol® FG or Lupasol® PR and a liquid additive, polyethylenimine (B and C respectively), compared to HNBR alone (A) and NBR alone (D).

FIG. 8 shows images for healing of HNBR with or without a self-healing agent after each of them were subjected to rapid gas decompression (RGD).

FIG. 9 shows a micrograph of microcapsules which survive the elastomer compounding process.

FIG. 10 shows a top view of the strain distribution in a deformed full annular packer sealed against the drill pipe (A) and in an undeformed full annular packer (B).

FIG. 11 shows regions for applying self-healing materials in annular packers based on a sector model to analyze the internal strain distribution in a deformed full annular packer sealed against the drill pipe (A) and in an undeformed full annular packer (B).

### DETAILED DESCRIPTION

Elastomeric packers/sealing elements in blowout-preventers (BOPs) are used to seal around various pipe sizes. The variable ram packer consists of metallic inserts and elastomers that work as a coherent unit to create a seal. The elastomers that are currently used in the field undergo large deformations across the bore face, face recess and other critical regions during operation. The deformations result in a breakdown of the material that eventually leads to failure. In addition to the BOP packers, other high pressure high temperature (HP/HT) seals also have a number of failure modes related to cracking, such as rapid gas decompression and fatigue, leading to a lack of reliable sealing under HP/HT conditions.

Provided herein are methods for improving the reliability of packers and sealers including HP/HT sealers and BOP sealers/packers. The methods involve directing elastomeric materials with self-healing properties to specific areas in BOP packers which are susceptible to stress and cracking. The directed compositions described herein allow for cracks to be healed as soon as they are formed, thereby improving the reliability and application space of packers and seals, including BOP packers and HP/HT seals.

As used herein, in one embodiment, the term “elastomer” or “elastomeric” encompasses thermosets (e.g., polymers requiring vulcanization). In a further embodiment, the term “elastomer” or “elastomeric” encompasses thermoplastics. In yet another embodiment, the term “elastomer” or “elastomeric” encompasses a mixture of one or more thermosets and one or more thermoplastics. In one group of embodiments, any elastomer-based packer described herein is comprised of one or more of nitrile-butadiene rubber (NBR), hydrogenated nitrile butadiene rubber (HNBR), carboxylated nitrile butadiene rubber (XNBR), fluoroelastomers (FKM), perfluoroelastomers (FFKM), natural rubber (NR), and the like, or combinations thereof. In another group of embodiments, examples of the elastomeric material may include rubber, neoprene, nitrile rubber, hydrogenated nitrile rubber, carboxylated nitrile rubber, natural rubber, butyl rubber, ethylene-propylene rubber, epichlorohydrin, chlorosulfonated polyethylene, fluoroelastomers, and the like, or combinations thereof.

As used herein, “regions of high stress or high strain” in a BOP packer are typically determined using finite element analysis (FEA). For the purpose of this disclosure, the regions of strain in a packer during the operation of the BOP are classified from FEA as regions of strain comprising >90% of maximum strain for elongation at break (and noted as regions of large strain in the accompanying figures); regions of strain comprising >40% of maximum strain for elongation at break (and noted as regions of medium strain in the accompanying figures); and regions of strain comprising <40% maximum strain for elongation at break (and noted as regions of small strain in the accompanying figures). Accordingly, “regions of high strain” in a packer comprise regions of strain comprising at least >40% of maximum strain for elongation at break based on FEA; and preferably comprise regions of strain comprising >90% of maximum strain for elongation at break based on FEA. Such regions have a higher probability of cracking/tearing during the operation of the BOP. Although the accompanying figures only show FEA for regions of high strain, it will be understood that a corresponding analysis can be conducted to identify regions of high stress.

As used herein, “processing conditions encountered during compounding of the packer and during normal operation of the packer” relate to typical temperatures and pressures during compression molding of the packer. Strains induced in the elastomeric packer by these conditions would not crack any microcapsules described herein and would not trigger any healing of the elastomer by any liquid additive described herein. Typical temperatures during compression molding of the packer may vary from about 100 deg. C. to about 210 deg. C., although other temperature ranges are possible and are expressly contemplated herein as being within the scope of embodiments described herein. Typical pressures during compression molding of the packer may vary from about 90 psi to about 110 psi, although other pressure ranges are possible and are expressly contemplated herein as being within the scope of embodiments described herein.

As used herein, “crack-propagating conditions in the elastomer” refers to conditions which impose higher than normal stress/strain in the BOP packer. During normal operations, the BOP packers are typically subjected to a temperature range of about 0 deg. C. to about 177 deg. C. under about 15-20 ksi pressures. Under these conditions, the microcapsules in the elastomer would not break open by themselves, and the liquid additive would not trigger healing of the elastomer. However, the combination of high temperatures (HT) and high pressures (HP) along with cyclic loading can trigger cracks in the elastomeric packer. For example, microcracks from which failure of the BOP can originate may arise from slippage between polymer chains producing reorientation where the chains acquire a state of tension. Subsequently, local scission occurs which then propagates to neighboring chains causing cracks that propagate irreversibly. Under such crack propagating conditions, the microcapsules would break open and initiate healing of the elastomer, or, the liquid additive would initiate healing of the elastomer.

Accordingly, in a first aspect, provided herein are blowout preventers (BOP) comprising
at least one elastomeric packer; and
at least one self-healing material, directed to regions of high stress or high strain in said packer, dispersed therein.

In one group of embodiments, the self-healing material is directed to regions of high stress in the packer. In another group of embodiments, the self-healing material is directed to regions of high strain in the packer.

In one group of embodiments, the BOP comprises a variable bore ram packer.

In some embodiments, the regions of high stress or high strain in a variable bore ram packer are one or more of
(a) face recess region behind the 3 o'clock and 9 o'clock inserts, axially both top and bottom;
(b) elastomer region immediately below the insert head spanning the entire boreface; or
(c) elastomer regions closest to interface with metal side wings;
   or a combination thereof.

In one group of embodiments, the regions of high stress or high strain in a variable bore ram packer are shown in FIG. 5. Other regions of high stress or high strain in variable bore ram packers which are identifiable using the methods described herein are also expressly contemplated within the scope of embodiments described herein as regions suitable for directing the placement of self-healing materials described herein.

In another group of embodiments, the BOP comprises an annular packer.

In some embodiments, the regions of high stress or high strain in an annular packer are one or more of
(a) regions on the bore-face located circumferentially between the inserts; or
(b) top face of the elastomeric packer in between the inserts from top to bottom;
   or a combination thereof.

In one group of embodiments, the regions of high stress or high strain in an annular packer are shown in FIG. 10. Other regions of high stress or high strain in annular packers which are identifiable using the methods described herein are also expressly contemplated within the scope of embodiments described herein as regions suitable for directing the placement of self-healing materials described herein. Annular BOPs allow slow rotation and vertical movement of the drill pipe while maintaining the sealing. Annular BOP preventers currently available include and are not limited to Shaffer spherical BOP, Annular Cameron DL, Annular Hydril GK and Annular Hydril GL, and the like and packers for all such BOPs are contemplated within the scope of embodiments described herein.

In yet another group of embodiments, the BOP comprises a fixed bore ram packer. In certain embodiments, the regions of high stress or high strain in a fixed bore ram packer are identified using methods similar to the methods described herein and are suitable for directing the placement of self-healing materials described herein.

In some embodiments, the self-healing material comprises a self-healing agent encapsulated by a coating material defining a microcapsule, the coating material of the microcapsule being stable at processing conditions encountered during compounding of the packer and during normal operation of the packer, yet, unstable under crack-propagating conditions in the elastomer.

In some embodiments, the self-healing agent comprises a thermosetting polymer. In some of such embodiments, said self-healing agent comprises a nitrocellulose cement, a cyanoacrylate adhesive, an epoxy based adhesive, an aliphatic polyurethane, an isocyanate terminated aliphatic urethane prepolymer, or dicyclopentadiene (DCPD), or a combination thereof.

In some other embodiments, the self-healing material comprises a polar liquid additive. In some of such embodiments, the polar liquid additive comprises polyethylenimines (PEI).

In one group of embodiments, said elastomeric packer comprises nitrile-butadiene rubber (NBR), hydrogenated nitrile butadiene rubber (HNBR), carboxylated nitrile butadiene rubber (XNBR), fluoroelastomers (FKM), perfluoroelastomers (FFKM), or natural rubber (NR), or a combination thereof.

In one group of embodiments, where the self-healing material is a self-healing agent encapsulated by a coating material defining a microcapsule, the coating material of said microcapsule comprises a urea-formaldehyde polymer, an epoxy, a silicone, or a combination thereof.

Also provided herein is a method for increasing the life of a blowout preventer (BOP) comprising
dispersing at least one self-healing material directed to regions of high stress or high strain in the BOP packer.

Further provided herein is a computer-implemented method for identifying an optimized microcapsule diameter, for placement of microcapsules in regions of high stress or high strain in a BOP packer, comprising
i) acquiring crack-inducing temperature, chemical exposure, and pressure cycling data, including ramp rates from field operation of the BOP;
ii) applying finite element analysis (FEA) to the data from step i) to obtain a multi-axial state of stress and strain for the BOP packer (Strain State 1 (S1));
iii) performing parametric analysis on a microcapsule embedded in different regions of S1, with design variables comprising radius (R), thickness (t), material modulus (E) and material fracture Strength (S) and obtaining a set R1 containing all combinations of design variables R, t, E and F that allow the microcapsule stress to exceed S;
iv) acquiring pressure, temperature, chemical exposure, pressure cycle data, including ramp rates from molding and assembly of the BOP packer;
v) applying FEA to the data from step iv) to obtain a multi-axial state of stress and strain for the BOP packer (Strain State 2 (S2));
vi) performing parametric analysis on a microcapsule embedded in different regions of S2, with design variables comprising radius (R), thickness (t), material modulus (E) and material fracture Strength (S) and obtaining a set R2 containing all combinations of design variables R, t, E and F that limit the microcapsule stress be lower than S;
vii) obtaining the intersection of sets R1 and R2 defined as set R3, that will simultaneously satisfy constraints listed in (iii) and (vi); and
viiii) identifying microcapsule diameters which fit within R3.

Also provided herein is a computer-implemented method for identifying regions of high stress or high strain in a BOP packer, to direct placement of at least one self-healing material comprising a polar liquid additive or a microcapsule comprising a self-healing agent, comprising:
i) acquiring crack-inducing temperature, chemical exposure, and pressure cycling data, including ramp rates from field operation or computer simulation of the BOP;
ii) applying finite element analysis (FEA) to the data from step i) to obtain one or more regions in the packer that crack, degrade or experience high strain or high stress; and
iii) replacing the baseline BOP packer in said regions with a BOP packer comprising at least one self-healing material comprising a liquid additive or with a BOP packer comprising microcapsules comprising a self-healing agent.

In a typical blowout preventer, sheets of elastomer are positioned between metallic inserts and then the elastomeric sheets are subjected to the process of transfer or compression molding. In accord with the methods described herein, sheets of elastomers are replaced with sheets of self-healing elastomers in the regions of high strain or high stress as described herein. Alternatively, elastomer is injected in the packer assembly. In accord with the methods described herein, elastomers which are injected are replaced with self-healing elastomers in the regions of high strain or high stress as described herein.

In addition to maintaining integrity during normal well operations and/or a “kick”, the presently described BOPs comprising modified elastomers in the packer are also useful for sealing against the drill pipe during a “stripping” operation. During a stripping operation, the drill pipe is pulled from the well bore with the blowout preventer closed against the drill pipe. This results in wear and tear on the ram packer, particularly the elastomeric sealing element. Accordingly, also contemplated within the scope of embodiments presented herein is the use of the presently described BOPs during said stripping operations. Further contemplated within the scope of embodiments presented herein is the use of the BOPs comprising modified elastomers in the packer to regulate and monitor wellbore pressure; shut in the well (e.g. seal the void, annulus, between drill pipe and casing); “kill” the well (prevent the flow of formation fluid, influx, from the reservoir into the wellbore); seal the wellhead (close off the wellbore); or sever the casing or drill pipe during an emergency. U.S. application Ser. No. 14/964,639 describes certain blow out preventers having a modified design, which disclosure is incorporated herein by reference, and such blow out preventers are also contemplated for modification of elastomers therein using the methods and compositions provided herein.

Also contemplated within the scope of embodiments presented herein are seals/packers in general (e.g., elastomer based seals/packers), wherein regions of high stress and/or high strain can be identified using the methods described herein and said seals/packers can then be modified with self-healing material directed to regions of high stress and high strain as described herein.

### EXAMPLES

In FIG. 6, compression fatigue tests results are compared for controlled/baseline HNBR compounds along with HNBR compounds modified with Lupasol® FG and Lupasol® PR. The baseline and the modified samples were compounded using the standard compression molding process to generate elastomer slabs. The button samples were then machined from those slabs. Cyclic compressive loads were applied on the samples until they cracked. The results indicate improved fatigue life with addition of Lupasol® compounds.

In FIG. 7, trouser tear test results (performed according to ASTM D624 standard) are compared for benchmark HNBR-NBR compounds and also for HNBR compounds modified with Lupasol® FG, Lupasol® PR. The benchmark and the modified elastomers were also compounded using the standard compression molding process to generate elastomer sheets. The tear-trouser samples were punched out from the sheets. The results indicate that Lupasol® additive samples have improved tear strength.

In FIG. 8, the cross-sectional micro-graphs of controlled HNBR compounds along with HNBR compounds modified with Lupasol® FG are compared. Two identical samples of each baseline and self-healing elastomer were used in the experiment. All the samples were subjected to rapid gas decompression test (according to the standard NACE TM-0297-1997) in presence of 1000 psi CO₂ gas pressure. The exposure time was kept constant at 24 hrs and the operating temperature was kept at 100 deg.C. The depressurization rate was 1000 psi/minute. Pre-healed cross-sectional micro-graphs were initially captured for the baseline and the self-healing elastomer sample. The post-healing technique involved volumetrically compressing the samples under 100 lbs. of axial load at 100 deg. C. for 15-20 hours. The post-healing technique was performed on the second (duplicate) set. After performing the post-healing process, the cross-sectional micro-graphs of baseline and self-healing additive samples were compared. The post-healed cross-sectional micro-graphs indicated that the cracks were healed in the HNBR compounds modified with Lupasol® FG (PEI).

HNBR matrix modified with the microcapsules were subjected to the conventional compounding process (i.e. compression molding). The scanning electron micro-graph in FIG. 9 shows that the capsules survived the compounding process without any premature cracks.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A blowout preventer (BOP) comprising
at least one elastomeric packer; and
at least one self-healing material, directed to regions of high stress or high strain in said packer, dispersed therein.

2. The BOP of claim 1 which comprises a variable bore ram packer.

3. The BOP of claim 2, wherein the regions of high stress or high strain in said packer are one or more of
(a) face recess region behind the 3 o'clock and 9 o'clock inserts, axially both top and bottom;
(b) elastomer region immediately below the insert head spanning the entire boreface; or
(c) elastomer regions closest to interface with metal side wings;
or a combination thereof.

4. The BOP of claim 1 which comprises an annular packer.

5. The BOP of claim 4, wherein the regions of high stress or high strain in said packer are one or more of
(a) regions on the bore-face located circumferentially between the inserts; or
(b) top face of the elastomeric packer in between the inserts from top to bottom;
or a combination thereof.

6. The BOP of claim 1 which comprises a fixed bore ram packer.

7. The BOP of claim 1, wherein the self-healing material comprises a self-healing agent encapsulated by a coating material defining a microcapsule, the coating material of the microcapsule being stable at processing conditions encountered during compounding of the packer and during normal operation of the packer, yet, unstable under crack-propagating conditions in the elastomer.

8. The BOP of claim 3, wherein said self-healing agent comprises a thermosetting polymer.

9. The BOP of claim 3, wherein said self-healing agent comprises a nitrocellulose cement, a cyanoacrylate adhesive, an epoxy based adhesive, an aliphatic polyurethane, an isocyanate terminated aliphatic urethane prepolymer, or dicyclopentadiene (DCPD), or a combination thereof.

10. The BOP of claim 1, wherein the self-healing material comprises a polar liquid additive.

11. The BOP of claim 6, wherein the polar liquid additive comprises polyethylenimines.

12. The BOP of claim 1, wherein said elastomeric packer comprises nitrile-butadiene rubber (NBR), hydrogenated nitrile butadiene rubber (HNBR), carboxylated nitrile butadiene rubber (XNBR), fluoroelastomers (FKM), perfluoroelastomers (FFKM), or natural rubber (NR), or a combination thereof.

13. The BOP of claim 1, wherein the coating material of said microcapsule comprises a urea-formaldehyde polymer, an epoxy, a silicone, or a combination thereof.

14. A method for increasing the life of a blowout preventer (BOP) comprising
dispersing at least one self-healing material directed to regions of high stress or high strain in the BOP packer.

15. A computer-implemented method for identifying an optimized microcapsule diameter, for placement of microcapsules in regions of high stress or high strain in a BOP packer, comprising
i) acquiring crack-inducing temperature, chemical exposure, and pressure cycling data, including ramp rates from field operation of the BOP;
ii) applying finite element analysis (FEA) to the data from step i) to obtain a multi-axial state of stress and strain for the BOP packer (Strain State 1 (S1));
iii) performing parametric analysis on a microcapsule embedded in different regions of S1, with design variables comprising radius (R), thickness (t), material modulus (E) and material fracture strength (F) and obtaining a set R1 containing all combinations of design variables R, t, E and F that allow the microcapsule stress to exceed S;
iv) acquiring pressure, temperature, chemical exposure, pressure cycle data, including ramp rates from molding and assembly of the BOP packer;
v) applying FEA to the data from step iv) to obtain a multi-axial state of stress and strain for the BOP packer (Strain State 2 (S2));
vi) performing parametric analysis on a microcapsule embedded in different regions of S2, with design variables comprising radius (R), thickness (t), material modulus (E) and material fracture strength (F) and obtaining a set R2 containing all combinations of design variables R, t, E and F that limit the microcapsule stress be lower than S;
vii) obtaining the intersection of sets R1 and R2 defined as set R3, that will simultaneously satisfy constraints listed in (iii) and (vi); and
viiii) identifying microcapsule diameters which fit within R3.

16. A computer-implemented method for identifying regions of high stress or high strain in a BOP packer, to direct placement of at least one self-healing material comprising a polar liquid additive or a microcapsule comprising a self-healing agent, comprising:
i) acquiring crack-inducing temperature, chemical exposure, and pressure cycling data, including ramp rates from field operation or computer simulation of the BOP;
ii) applying finite element analysis (FEA) to the data from step i) to obtain one or more regions in the packer that crack, degrade or experience high strain or high stress; and
iii) replacing the baseline BOP packer in said regions with a BOP packer comprising at least one self-healing material comprising a liquid additive or with a BOP packer comprising microcapsules comprising a self-healing agent.
